(19) United States
(12) Patent Application Publication
(10) Pub. No.: US 2025/0196651 A1
(43) Pub. Date: Jun. 19, 2025

(54) METHOD FOR REGULATING A GENERATOR BRAKING TORQUE OF AN ELECTRIC DRIVE FOR A VEHICLE, IN PARTICULAR A UTILITY VEHICLE, COMPUTER PROGRAM, COMPUTER-READABLE MEDIUM, CONTROL DEVICE, ELECTRIC DRIVE OR ELECTRIC BRAKING SYSTEM AND VEHICLE

(71) Applicant: ZF CV Systems Global GmbH, Bern (CH)

(72) Inventors: Thomas Kattenberg, Vechelde (DE); Johannes Heseding, Hannover (DE); Felix Müller-Deile, Hannover (DE); Winfried Fakler, Eriskirch (DE); Franz Bitzer, Friedrichshafen (DE); Andreas Marx, Seelze (DE)

(21) Appl. No.: 19/064,445

(22) Filed: Feb. 26, 2025

Related U.S. Application Data
(63) Continuation of application No. PCT/EP2023/074607, filed on Sep. 7, 2023.

(30) Foreign Application Priority Data
Sep. 14, 2022 (DE) 10 2022 123 478.9

(51) Int. Cl. B60L 7/24; B60L 7/18

(52) U.S. Cl. CPC B60L 7/24; B60L 7/18; B60L 2240/465

(57) ABSTRACT

A method is for regulating a generator braking moment of an electric drive for a vehicle, in particular a utility vehicle. The method includes: sensing a call for braking for the purpose of braking the vehicle using a setpoint braking moment; and, regulating the generator braking moment in dependence on the setpoint braking moment and on a trigger condition. The regulating is effected within a plurality of cycles. Within a cycle, changing of a generator braking moment provided by the electric drive is effected. Each of the cycles includes a first sub-cycle and a second sub-cycle. In the first sub-cycle, the changing includes reducing the generator braking moment and, in the second sub-cycle, the changing includes increasing the generator braking moment.

### CROSS-REFERENCE TO RELATED APPLICATIONS

This application is a continuation application of international patent application PCT/EP2023/074607, filed Sep. 7, 2023, designating the United States and claiming priority from German application 10 2022 123 478.9, filed Sep. 14, 2022, and the entire content of both applications is incorporated herein by reference.

### TECHNICAL FIELD

The disclosure relates to a method for regulating a generator braking moment of an electric drive for a vehicle, in particular a utility vehicle. The disclosure also relates to a computer program and/or computer-readable medium, a control device for a vehicle, in particular a utility vehicle, an electric drive or an electric braking system for a vehicle, in particular a utility vehicle, and a vehicle, in particular a utility vehicle.

The disclosure relates in particular to the vehicles sector, in particular utility vehicles, including trailers, having an electronically regulated braking system (electronic brake system, EBS, or trailer electronic brake system, TEBS) and at least one axle that can be driven electrically by an electric drive (eDrive) via a central drive and/or an individual wheel drive, the electric drive being configured for regenerative braking. In other words, the electric drive may be operated as a wear-free endurance brake, and thereby enables braking energy to be recovered in the form of electrical energy (recuperation) during deceleration. Here, a generator braking moment has the effect of decelerating one or more wheels of the vehicle.

### BACKGROUND

DE 10 2019 135 087 A1 discloses a method for regulating the slip of a vehicle wheel driven by an electric drive, including at least the following steps: in a moment control process in a moment control step, activating the electric drive of the vehicle wheel using an actual drive moment, ascertaining a wheel rotational speed and a wheel slip of the vehicle wheel and evaluating the wheel slip by an instability criterion to ascertain whether an instability is present, if instability is recognized, direct or indirect transition to slip regulation of the wheel slip to a setpoint slip by actuating the electric drive, ascertaining whether an end criterion for ending the slip regulation is fulfilled, if the end criterion is fulfilled, returning to the moment control in the moment control step. Drive regulation in this case may be combined with ABS regulation. In this way, electric braking, or recuperation, may be superimposed with a subordinate friction braking with constant moment. Thus, if the vehicle wheel has a tendency to lock, friction braking may be regulated via the wheel brake via an ABS regulating procedure, via the central brake control means (ABS regulating means), with simultaneous action of the wheel-hub motor, in particular for the purpose of recuperation.

DE 10 2012 217 679 A1 discloses a slip-regulated braking system for an electrically driven motor vehicle, which includes, on the wheels of at least one axle, friction brakes that are activated by a friction-brake control means, at least one electric machine, which is connected to at least one wheel and is activated an electric-drive control means, means for sensing a call for deceleration, in particular a brake pedal having a pedal-angle sensor, a wheel-slip regulating means and a moment distribution means. The means for sensing a call for deceleration in this case is or are connected to the wheel-slip regulating means, which specifies defines setpoint braking moments for each wheel in accordance with the call for deceleration, the wheel-slip regulating means being connected to a moment distribution means that is connected to the friction-brake control means and the electric-drive control means and, in accordance with the setpoint braking moments, specifies calls for friction braking to the friction-brake control means and calls for generator braking to the electric-drive control means. Further items of information relating to the driving dynamics are transmitted from a status observer to the wheel-slip regulating means. The electric-drive control means sends the currently applied generator braking moment(s) and/or the maximum generator braking moment(s) that can be generated to the moment distribution means, and the division between calls for friction braking and a call or calls for generator braking is effected in consideration of the currently applied and/or maximum generator braking moment(s) that can be generated.

For a high degree of recuperation of braking energy and an associated increase in range of an electrically driven vehicle, the electric drive must be able to set the highest possible generator braking moment with corresponding slip values. In the case of heavy braking, in particular, the friction brake may also be active. If the slip during braking becomes too great, the braking moment must be limited in order to prevent locking.

However, there is the problem that the slip depends on an axle load and a on roadway, or a coefficient of friction between the roadway and a wheel of the vehicle. For a given torque, dynamic changes in axle load result in a change in slip that must be corrected. When the roadway changes, the μ-slip curve (see FIG. 1) alters, with a possibly altered adhesion maximum at which maximum power transmission in the longitudinal direction is possible. This raises the question of which fixed and/or operationally tracked setpoint value the slip should be limited to and/or regulated to. If the slip is too high and therefore too close to the adhesion maximum, there is not, or no longer, sufficient lateral guidance of the tire, and the vehicle becomes unstable. In the unstable range of the u-slip curve, that is, in the case of slip values that are greater than the slip value at the adhesion maximum, self-amplification effects also occur, as the possible power transmission decreases again with increasing slip. If the slip is too low, the adhesion potential and therefore efficiency and braking distance remain unutilized.

In the case of purely slip-based regulation, there is additionally the problem that the vehicle reference speed must be known with sufficient accuracy in order to calculate the wheel-specific slip. Otherwise, for example, either braking distance is wasted during braking if the calculated vehicle reference speed is too high, or the vehicle becomes unstable if the calculated vehicle reference speed is too low. In both driving and braking situations, when only the electric drive is used for regenerative braking, the vehicle reference speed is typically known from the freewheeling front axle. However, when braking is applied simultaneously to all axles, in particular when ABS regulation is not active, the vehicle reference speed can only be estimated.

For braking, there is a well-known regulating principle of, in particular, a pneumatic anti-blocking system (ABS). The ABS substantially uses the change in wheel speed over time, or the wheel acceleration, to recognize the locking of a wheel and to launch regulation. This makes the ABS robust with respect to the reference speed, as the wheel speed/acceleration is independent of the reference speed. With the launching of regulation according to ABS, a braking force is first reduced via a friction brake, such that a locked wheel starts up again without braking and a positive wheel acceleration results. A braking force is then built up again until a locking tendency is again recognized via the wheel deceleration. This also makes the ABS robust with respect to varying surfaces, as in each case braking force is built up until there is a tendency toward locking. In other words, a “running back and forth” is performed in an interval of slip values that are less than the slip value at an adhesion maximum. At the same time, lateral guidance and steerability are provided in the phases of unbraked rolling. A disadvantage is that in some phases no braking force is applied, and braking distance is wasted.

### SUMMARY

It is an object of the disclosure to enhance the prior art and to enable improved regulation for braking of a vehicle, in particular a utility vehicle. Configurations according the disclosure can in this case achieve the object of achieving a regulation of braking that is robust with respect to possible errors in the reference speed and to changing surfaces, and that opens up the possibility of generating a continuous braking moment that is as continuous as possible.

The aforementioned object is, for example, achieved by various methods, computer programs, computer readable mediums, electric drives, electric braking systems, and vehicles according to the disclosure.

Provided according to the disclosure is a method for regulating a generator braking moment of an electric drive for a vehicle, in particular a utility vehicle. The method includes: sensing a call for braking, for the purpose of braking the vehicle, in particular a utility vehicle, using a setpoint braking moment; regulating the generator braking moment in dependence on the setpoint braking moment and on a trigger condition, wherein the regulating is effected within a plurality of cycles, wherein within a cycle changing of a generator braking moment provided by the electric drive is effected, wherein each of the cycles includes a first sub-cycle and a second sub-cycle, and wherein in the first sub-cycle the changing includes reducing the generator braking moment, and in the second sub-cycle the changing includes increasing the generator braking moment.

The vehicle, in particular the utility vehicle, is referred to below as the vehicle. The vehicle includes wheels that can be braked by regenerative braking using the generator braking moment by the electric drive. A driver and/or an automated driving function may in this case provide or trigger a call for braking, which causes the vehicle, an axle of the vehicle and/or one of the wheels to be braked using the setpoint braking moment by the electric drive and/or a friction-braking device.

The regulating of the generator braking moment is effected in dependence on the setpoint braking moment and a trigger condition, and within a plurality of cycles. The trigger condition in this case is a condition that triggers the regulation. If the trigger condition is fulfilled, regulation is effected. However, if the trigger condition is not fulfilled, regulation may not take place. A cycle in this case is a non-zero and finite time interval in which regulation is effected according to a predefined pattern, or scheme. Within a cycle, a systematic and rule-based changing of the generator braking moment provided by the electric drive is effected. It was recognized that it is possible to regulate the total braking moment effectively and reliably by regulating the generator braking moment. A plurality of cycles are performed for the purpose of regulating the generator braking moment, to enable the use of comparatively short cycles and to utilize, compared to other braking systems, the comparatively high control dynamics of the electric drive. Here, use of the electric drive to provide the generator braking moment already results in regulation comparable to ABS, which, owing to the dynamics and control quality of the electric drive, already results in improved controllability of the generator braking moment, compared to ABS, and thus in deceleration of the vehicle.

Each of the cycles includes a first sub-cycle and a second sub-cycle. In principle, each cycle may therefore be understood as consisting of two sub-intervals. In the first sub-cycle, the changing includes reducing the generator braking moment and, in the second sub-cycle, changing includes increasing the generator braking moment. By reducing the generator braking moment, for example, a slip that fulfils the trigger condition is reduced by a reduction of the generator braking moment in the first sub-cycle, in order then essentially to be increased again in the second sub-cycle, until the cycle ends.

In other words, a targeted modulation over time, for example a ramp-type build-up and reduction, of the braking moment generated by the electric drive is used to adapt the regulation to the roadway or the surface and to achieve sufficient non-dependence on, or robustness with respect to, the reference speed. Owing to the good response time of the electric drive, the regulating/modulation cycles can be much shorter than in classic pneumatic ABS. It is in principle therefore possible to generate a braking moment that is ideally permanent. The braking distance and braking performance are improved while maintaining stability. Recuperation is possible. Self-adaptation to the roadway may be effected, as the braked wheel or axle is selectively overbraked until the tendency to lock is recognized. Ideally, the adhesion maximum is attained and recognized. Changing of the generator braking moment makes it possible to adjust the total braking moment.

According to various embodiments, the generator braking moment is changed in such a way that the generator braking moment does not change sign within a cycle. A residual generator braking moment remains, and a change of tooth flank in a transmission of the electric drive is avoided. This protects the mechanics of the electric drive and increases its service life.

According to various embodiments, a new cycle begins upon the trigger condition being fulfilled. This means that, upon the trigger condition being fulfilled again, for example if the generator braking moment increases or if the friction coefficient of the roadway changes, a reduction of the generator braking moment is achieved immediately. For this, the previous cycle may be interrupted in favor of a new cycle. This is advantageous in particular in the case of varying roadway characteristics and/or a changing driving situation. The new cycle may follow the previous cycle immediately, that is, without a time interval, in order to enable rapid regulation.

According to various embodiments, the changing is effected according to a variable rate of change. The rate of change in this case may be dependent on the setpoint braking moment and on variables relating to the trigger condition. Regulation can thus be effected according to the situation.

According to various embodiments, the rate of change depends on a roadway characteristic and/or driving status. For example, in the case of driving on a comparatively smooth roadway, the generator braking moment may be reduced comparatively rapidly, and in the case of driving on a less smooth roadway, the generator braking moment may be reduced more slowly. Regulation may thus be effected in a manner appropriate to the situation; rate of change may be constant or variable within a sub-cycle.

According to various embodiments, the rate of change is limited in such a way that the trigger condition is not fulfilled within a predefined cycle segment. The cycle segment in this case is a time interval within a cycle, in particular within the second sub-cycle. This allows particularly reliable and safe deceleration. The cycle segment can be determined by inertia characteristics and/or kinematic characteristics of the electric drive.

According to various embodiments, within one of the cycles, the reducing is effected at a first rate of change and the increasing at a second rate of change, wherein the first rate of change is different in amount from the second rate of change. The mutually differing rates of change allow flexible changing within a cycle. This means that a given difference in the generator braking moment may be effected at different time intervals. Preferably in this case, the first rate of change is smaller in amount than the second rate of change, for example in order to reduce the generator braking moment only comparatively slowly upon fulfillment of the trigger condition and thus avoid an excessive reduction in the generator braking moment. It is thereby possible to prevent braking potential from remaining unutilized.

According to various embodiments, a change in braking moment relating to the generator braking moment is effected within one of the cycles, and the regulating is effected in consideration of a previous change in braking moment of a previous cycle. The change in braking moment may be defined as a difference between the generator braking moment at the beginning of the cycle and a minimum generator braking moment within the cycle. The regulating of the generator braking moment is effected in dependence on the change in braking moment of the previous cycle. For example, rates of change for changing the generator braking moment in the current cycle may be based on the rates of change of the previous cycle. It is thereby possible to achieve, for the current cycle, a suitable estimate of parameters for regulating the generator braking moment.

According to various embodiments, the change in braking moment is selected in consideration of a first threshold-value condition relating to the previous change in braking moment. The first threshold-value condition in this case may depend on a current generator braking moment and/or a regulating capacity of the electric drive. If the threshold-value condition is fulfilled, for example if the change in braking moment is less than a predefined threshold value, the regulating is effected in such a way that the generator moment is reduced relative to the previous cycle, as there is less grip on the roadway and less moment can be released. If the threshold value condition is not fulfilled, for example the change in braking moment is greater than a predefined threshold value, the regulating is effected in such a way that the generator moment is increased relative to the previous cycle, as there is greater grip on the roadway and more moment can be released.

According to various embodiments, the trigger condition depends on a wheel acceleration, or the wheel acceleration. A tendency toward wheel locking can thereby be recognized effectively. Alternatively or additionally, the trigger condition therefore depends on a change in the wheel acceleration over time, a slip, a total braking moment and/or a change over time in the total braking moment.

According to various embodiments, the method further includes the step of: regulating a friction-braking moment, provided by a friction-braking system, in dependence on a second threshold-value condition relating to the generator braking moment. The second threshold-value condition in this case may depend on the regulating capacity of the electric drive. If the second threshold-value condition is fulfilled, for example if the generator braking moment is less than a predefined threshold value, a reduction in the friction-braking moment is effected so that more braking moment can be applied by the electric drive. Otherwise, if the second threshold-value condition is not fulfilled, for example if the generator braking moment is greater than the predefined threshold value and/or a further threshold value, the friction-braking moment is increased so that less braking moment has to be applied by the electric drive, and the regulating capacity thus increases again.

According to various embodiments, slip-based regulating of the generator braking moment is effected between two cycles. It is possible to perform a change-over between the regulation described above and continuous slip-based regulation. After modulated overbraking has been effected once or multiple times and it has been ensured that the optimum adhesion has been attained in the cycles, continuous slip-based regulation may then be effected with knowledge of the maximum transmissible moment. In this case, the cycles may be understood as test braking operations, which is used to determine how far the (continuously) delivered moment is from the maximum adhesion limit, or to what extent this is utilized and what lateral guidance reserve currently exists.

According to various embodiments, upon the trigger condition being fulfilled, reducing of the generator braking moment is effected to a predefined proportion of the generator braking moment upon the fulfilling of the trigger condition. The generator braking moment at the point in time at which the trigger condition is fulfilled is thus used as a reference for a generator braking moment that is initially to be set by reduction. For example, upon the trigger condition being fulfilled, the generator braking moment may be reduced to 20% in order to effectively reduce the braking moment in such a way that safe braking is possible.

According to a further aspect of the disclosure, a computer program and/or computer readable medium is/are provided. The computer program and/or computer-readable medium includes/include instructions that, upon the program, or instructions, being executed by a computer, cause the computer to perform the method described herein and/or the steps of the method described herein. The computer program and/or computer-readable medium may include instructions for performing steps of the method described as optional and/or advantageous, in order to achieve a corresponding technical effect.

Provided according to a further aspect of the disclosure is a control device for a vehicle, in particular a utility vehicle. The control device is configured to perform the method described herein. The control device may be configured to perform steps of the method described as optional and/or advantageous, in order to achieve a corresponding technical effect.

Provided according to a further aspect of the disclosure is an electric drive or an electric braking system for a vehicle, in particular a utility vehicle. The electric drive or the braking system includes the control device described herein. The control device in this case is exclusively part of the electric drive or of the braking system. Communication between the electric drive and the braking system can be rendered unnecessary because of the regulation. The electric drive or the braking system may in this case act as a master and initiate regulation on the basis of items of received information.

Provided according to a further aspect of the disclosure is a vehicle, in particular a utility vehicle. The vehicle includes the control device described herein. The vehicle and/or the control device may be configured to perform steps of the method described as optional and/or advantageous, in order to achieve a corresponding technical effect.

### BRIEF DESCRIPTION OF DRAWINGS

The invention will now be described with reference to the drawings wherein:

FIG. 1 shows a schematic representation of a u-slip curve;

FIG. 2 shows a schematic representation of an overview of a vehicle, in particular a utility vehicle, according to an embodiment of the disclosure;

FIG. 3 shows a schematic representation of a sequence diagram of a method according to an embodiment of the disclosure; and,

FIG. 4 shows a schematic representation of a braking-moment curve with a braking moment as a function of time.

### DETAILED DESCRIPTION

FIG. 1 shows a schematic representation of a μ-slip curve 400. Here, a coefficient of friction μ is plotted as a function of a slip S. The μ-slip curve 400 shows two different curves 401, 402 for different surfaces. FIG. 1 describes problems with slip-based regulation.

When a roadway changes, the μ-slip curve 400 alters a possibly altered adhesion maximum, 403, 404 at which a maximum force transmission between a wheel 210 and a roadway 215 is possible in the longitudinal direction. The curve 401 represented by a solid line is representative of a roadway 215 having a higher friction than the curve 402 represented by a dashed line. Accordingly, the adhesion maximum 403 of the curve 401 is greater than the adhesion maximum 404 of the curve 402. To the right of the adhesion maxima 403, 404, that is, at higher slip S, there is an unstable region, as indicated by the solid-line arrow.

In curve 401, the setpoint slip SS is too high and therefore too close to the adhesion maximum 403; there is no, or no longer, sufficient lateral guidance of a tire, and the vehicle 300a, 300b becomes unstable. In curve 402, the setpoint slip SS is too low; adhesion potential, and thus efficiency and braking distance, remain unutilized.

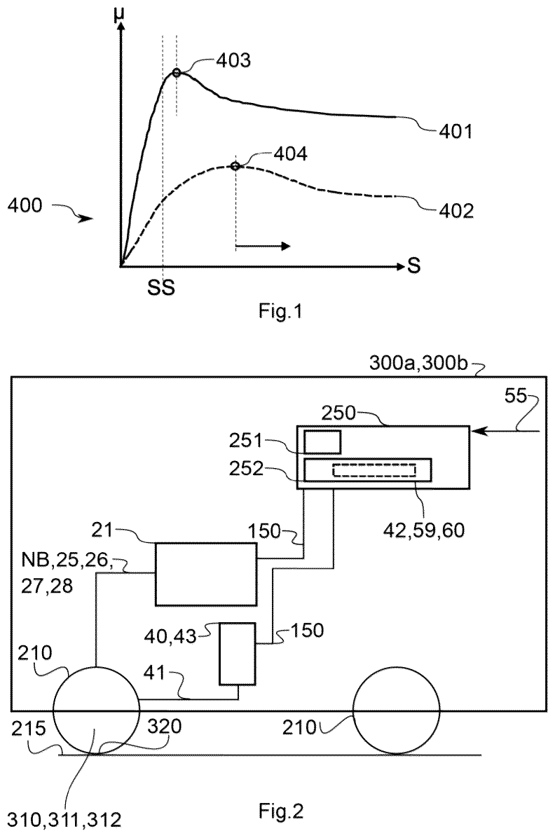

FIG. 2 shows a schematic representation of an overview of a vehicle 300a, in particular a utility vehicle 300b, according to an embodiment of the disclosure.

The vehicle 300a, in particular a utility vehicle 300b, is referred to in the following as the vehicle 300a, 300b. The vehicle 300a, 300b is a land vehicle and is, for example, a lorry, a bus, a trailer and/or a multi-unit vehicle.

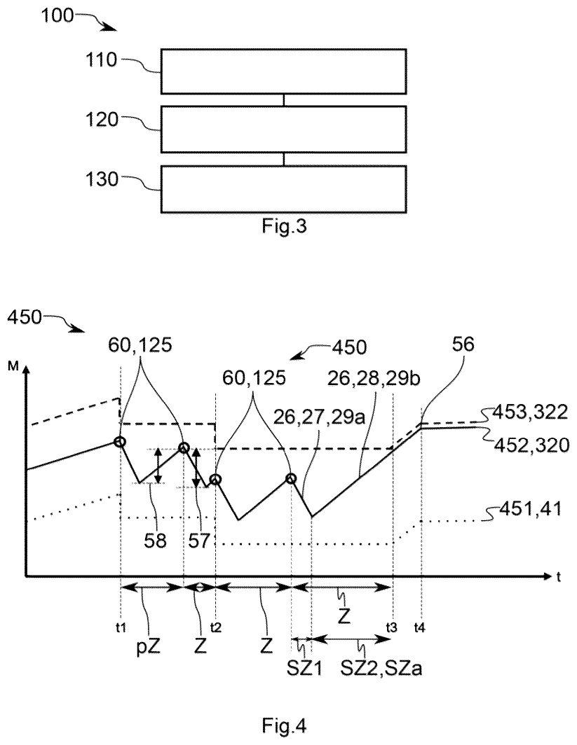

The vehicle 300a, 300b is configured to perform the method 100 described with reference to FIGS. 3 and 4. For this purpose, the vehicle 300a, 300b in the embodiment shown in FIG. 2 has an electric drive 21, a control device 250 and a friction braking system 40.

The control device 250 is configured to receive and evaluate a call for braking 55 for the purpose of braking the vehicle 300a, 300b using a setpoint braking moment 56. The call for braking 55 may include a signal triggered by, for example, a pedal actuation and/or an actuation of a retarder lever by a driver of the vehicle 300a, 300b and/or by an automated driving function, which is transferred to the control device 250, for example, via a vehicle bus (not shown). The control device 250 includes a processor 251 and a memory 252 to process and save items of information. The control device 250 is thus configured to perform the steps of the method 100 described in FIGS. 3 and 4. In particular, a threshold-value condition 59, a trigger condition 60 and a second threshold-value condition 42 are saved in the memory 252.

In the embodiment shown in FIG. 2, the control device 250 is connected to the electric drive 21 and the friction braking system 40 in order to exchange items of regulating information 150 with the electric drive 21 and the friction braking system 40, in particular in order to receive measurement values and send regulating signals.

The electric drive 21 is configured for regenerative braking NB. The electric drive 21 can generate a generator braking moment 25, which can result in a deceleration of the vehicle 300a, 300b. The electric drive 21 can effect changing 26, in particular reducing 27 and increasing 28 of the generator braking moment 25.

The friction braking system 40 is an electric braking system 43, or an electronically regulated braking system, and can apply a friction-braking moment 41. In an embodiment that is not shown, the friction braking system 40 is a pneumatic and/or hydraulic braking system.

The vehicle 300a, 300b shown in FIG. 2 has a plurality of wheels 210. The wheels 210 are positioned on a roadway 215. A total braking moment 320, mediated by the roadway 215 and produced by the electric drive 21 and the friction braking system 40 can act on each of the wheels 210. The total braking moment 320 is the sum of the generator braking moment 25 and the friction-braking moment 41.

The electric drive 21 may be configured as a so-called central drive to apply the generator braking moment 320 to a plurality of wheels 210 of an axle (not shown). In the embodiment shown in FIG. 2, the electric drive 21 is configured to apply the generator braking moment 320 to each wheel individually, although only the braking of one wheel 210 is illustrated schematically in FIG. 2.

The dynamics of each of the wheels 210 can be characterized by a measurable wheel acceleration 310 and a change in the wheel acceleration 311 over time. The wheel acceleration 310 and/or the change in wheel acceleration 311 over time may be acquired through measurement values from a wheel rotational-speed sensor (not shown) and/or through regulating information 150 from the electric drive 21. Owing to the acting total braking moment 320, there is a slip 312 between the wheel 210 and the roadway 215. The slip 312 may be ascertained, for example, through wheel speeds.

The electric drive 21 is configured to perform the friction coefficient estimation method described in the German patent application 10 2022 114 084.9 of Mar. 6, 2022, which had not yet been published at the time of filing. For this purpose, the electric drive is configured to apply a temporally predefined excitation torque to the wheel 210, the application of the excitation torque to the wheel 210 being effected periodically at a frequency, and to determine therefrom a change in slip in dependence on the excitation torque, the determination of the change in slip being effected in dependence on the frequency.

FIG. 3 shows a schematic representation of a sequence diagram of a method 100 according to an embodiment of the disclosure. The method 100 is a method 100 for regulating a generator braking moment 25 of an electric drive 21 for a vehicle 300a, 300b. Such a vehicle 300a, 300b is shown in FIG. 2. FIG. 3 is described with reference to FIG. 2.

The method 100 includes a sensing 110 of a call for braking 55 for the purpose of braking the vehicle 300a, 300b, using a setpoint braking moment 56. The setpoint braking moment 56 is a setpoint value for the total braking moment 320. However, the total braking moment 320 that can be applied may be limited, for example due to a high slip S and/or a low coefficient of friction μ (see FIG. 1), which can result in a situation in which braking using the setpoint braking moment 56 is not possible. Braking is then effected using a total braking moment 320 that is less than the setpoint braking moment 56. For this purpose, regulating 120 of the generator braking moment 25 is effected.

The regulating 120 of the generator braking moment 25 is effected in dependence on the setpoint braking moment 56 and on a trigger condition 60, with the regulating 120 being effected within a plurality of cycles Z, see FIG. 4. Within a cycle Z, changing 26 of the generator braking moment 25 provided by the electric drive 21 is effected, each of the cycles Z including a first sub-cycle SZ1 and a second sub-cycle SZ2. In the first sub-cycle SZ1, the changing 26 includes reducing 27 of the generator braking moment 25, and in the second sub-cycle SZ2 the changing 26 includes increasing 28 of the generator braking moment 25. Optionally, the cycle has a third sub-cycle (not shown), a constant generator braking moment 25 being provided in the third sub-cycle. Thus, no change in the generator braking moment 25 is effected in the third sub-cycle. The regulating 120 is described in more detail with reference to FIG. 4.

For the purpose of regulating 120 the generator braking moment 25, the control device 250 sends corresponding regulating information 150 to the electric drive 21.

The method 100 according to FIG. 3 further has the step of: regulating 130 a friction-braking moment 41, provided by a friction braking system 40, in dependence on a second threshold-value condition 42 relating to the generator braking moment 25. The second threshold-value condition 42 depends on the regulating capacity of the electric drive 21. If the second threshold-value condition 42 is fulfilled, for example if the generator braking moment 25 is less than a predefined threshold value, a reduction in the friction-braking moment 41 is effected. Otherwise, if the second threshold-value condition 42 is not fulfilled, for example if the generator braking moment 25 is greater than the predefined threshold value and/or a further threshold value, an increase in the friction-braking moment 41 is effected. For the purpose of regulating 120 the friction-braking moment 41, the control device 250 sends corresponding regulating information 150 to the friction braking system 40.

FIG. 4 shows a schematic representation of braking moment curves 450 with a braking moment M as a function of time t. Here, a curve 451 represented by a dotted line shows the dependence of the friction-braking moment 41 on the time t. A curve 452 represented by a solid line shows the total braking moment 320 as the sum of the friction-braking moment 41 and the generator braking moment 25 in dependence on the time t. The generator braking moment 25 as such is not represented in FIG. 4. A curve 453 represented by a dashed line shows a maximum total braking moment 322 as the sum of the friction-braking moment 41 and the maximum generator braking moment 25 that can be provided. FIG. 4 serves to further describe the method 100 according to FIG. 4.

The braking moment curves 450 shown as examples in FIG. 4 are characterized by four ordered time-points t1, t2, t3, t4, more precisely a first time-point t1, a second time-point t2, a third time-point t3 and a fourth time-point t4.

Initially and up to the first time-point t1, the regulation of the braking moment M is passive, that is, the electric drive 21 applies a constant generator braking moment 25 to a wheel 210, and the friction-braking moment 41 behaves according to a call for braking 55 and, in the example shown, it increases.

Between the first time-point t1 and the fourth time-point t4, the regulation 120 as in FIG. 3 is active. As can be seen in FIG. 4, the regulating 120 is effected in a plurality of cycles Z. Within a cycle Z, changing 26 of a generator braking moment 25 provided by the electric drive 21 is effected 26, each of the cycles Z including a first sub-cycle SZ1 and a second sub-cycle SZ2. In the first sub-cycle SZ1, the changing 26 includes reducing 27 of the generator braking moment 25, and in the second sub-cycle SZ2 the changing 26 includes increasing 28 of the generator braking moment 25.

A trigger condition 60 is fulfilled at the time-point t1. Upon the trigger condition 60 being fulfilled 125, a new cycle Z begins. Upon the trigger condition 60 being fulfilled 125, reducing 27 of the generator braking moment 25 is effected to a predefined proportion of the generator braking moment 25 upon the fulfilling 125 of the trigger condition 60. The trigger condition 60 depends on a wheel acceleration 310, a change in the wheel acceleration 311 over time, a slip 312, a total braking moment 320 and/or a change 321 in the total braking moment 320 over time.

The generator braking moment 25 is changed in such a way that the generator braking moment 25 does not change sign within a cycle Z. This means that the total braking moment 25 always remains greater than the friction-braking moment 41 according to the curve 451.

A change in braking moment 57 relating to the generator braking moment 25 is effected within one of the cycles Z. The change in braking moment 57 is the difference between the generator braking moment 25 at the beginning of a cycle Z and a minimum generator braking moment 25 within the cycle Z. The regulating 120 is effected in consideration of a previous change in braking moment 58 of a previous cycle pZ, the change in braking moment 58 of the previous cycle pZ being the difference between the generator braking moment 25 at the beginning of the previous cycle pZ and a minimum generator braking moment 25 within the previous cycle pZ. The change in braking moment 57 is selected in consideration of a first threshold-value condition 59 relating to the previous change in braking moment 58. If the delta-M, or the change in braking moment 57, is small, the moment M is reduced further than in the last cycle pZ. The grip on the roadway becomes less, and less moment M can be released. If the delta-M is large, a higher value for the moment M, that is, a greater first increase 29a, may be selected. The grip on the roadway becomes greater, and more moment more be released. Alternatively or additionally, the wheel acceleration 310 may be used. In this case, the generator braking moment 25 is reduced until the wheel acceleration 310 increases again and the wheel 210 begins to accelerate at a certain rate (after a locking tendency is recognized, the wheel 210 rotates faster again).

Within each of the cycles Z, reducing 27 is effected at a first rate of change 29a and increasing 28 at a second rate of change 29b, with the first rate of change 29a being different in amount from the second rate of change 29b. The respective rate of change 29, 29a, 29b depends on a roadway characteristic and/or driving status. In other words, the increases in some sections of the curve 452 of the total braking moment 320 in each of the cycles Z may be different from each other.

The rate of change 29 is limited in such a way that the trigger condition 60 is not fulfilled within a predefined cycle segment SZa. In particular, the second rate of change 29b is limited in order to achieve a limited increasing 28 in the second sub-cycle TZ2, as cycle segment SZa. A duration of the second sub-cycle TZ2 and/or the cycle segment SZa may be predicted, which together with the second rate of change 29b indicates whether a trigger condition 60 is likely to be fulfilled. It can thereby be ensured that increasing the moment M too rapidly does not unintentionally result in an excessive wheel deceleration and thus initiate the trigger condition 60. The release of the moment M should be effected only so rapidly that the resulting (theoretical) wheel deceleration remains below trigger condition 60.

In an embodiment that is not shown, the changing 26 of the generator moment 25 is effected in each of the cycles Z and in each sub-cycle SZ1, SZ2 according to a variable rate of change 29, that is, within the first sub-cycle SZ1 the first rate of change 29a changes and/or within the second sub-cycle SZ2 the second rate of change 29b changes.

If a step change in the friction value u occurs within a continuous regulation phase, that is, within one of the cycles Z, this results, when the generator braking moment 25 is being currently and continuously delivered, in a step change in the wheel rotational speed and/or the wheel deceleration, or wheel acceleration 310, and can be recognized via this. When a change in the friction value u is recognized, the system can switch over directly to modulation, and thus adaptation to the roadway 215 and/or a new cycle Z can be launched.

From the third time-point t3, the total braking moment 320 is equal to the maximum total braking moment 322. This means that the electric drive 21 can fully release a generator braking moment 25 called for by the control device 250.

If the maximum possible generator braking moment 322 has been released without a new trigger condition 60 occurring, then, if the call for braking is still present, the friction-braking moment 41 is increased to the currently sought value. If a new trigger condition 60 occurs in the meantime, a new regulation 120 is launched using the electric drive 21. Otherwise, regulation 120 is terminated.

From the fourth time-point t4, the regulation of the braking moment M is again passive, as before the first time-point t1. The setpoint braking moment 56 can be applied.

In addition, slip-based regulating of the generator braking moment 25 is effected between two cycles Z (not shown). After modulated overbraking has been effected once or multiple times and it has been ensured that the adhesion optimum has been reached in the cycles Z, a continuous slip-based regulation may then be effected with knowledge of the maximum transmissible moment M. After a defined period of time has elapsed, the system switches back from the slip-based regulation to the modulation as shown in FIGS. 3 and 4, in order to perform a new adaptation to the roadway 215. A new change-over to slip-based regulation is then effected, and so forth.

It is understood that the foregoing description is that of the preferred embodiments of the invention and that various changes and modifications may be made thereto without departing from the spirit and scope of the invention as defined in the appended claims.

### REFERENCE DESIGNATIONS (PART OF THE DESCRIPTION)

21 electric drive
25 generator braking moment
26 changing
27 reducing
28 increasing
29 rate of change
29a first rate of change
29b second rate of change
40 friction-braking system
41 friction-braking moment
42 second threshold-value condition
43 electric braking system
55 call for braking
56 setpoint braking moment
57 change in braking moment
58 previous change in braking moment
59 threshold-value condition
60 trigger condition
100 method
110 sensing
120 regulating
125 fulfilling
150 regulating information
210 wheel
215 roadway
250 control device
251 processor
252 memory
300a vehicle
300b utility vehicle
310 wheel acceleration
311 change in wheel acceleration over time
312 slip
320 total braking moment
321 change in the total braking moment over time
322 maximum total braking moment
400 μ-slip curve
401 curve
402 curve
403 adhesion maximum
404 adhesion maximum
450 braking-moment curve
451 curve
452 curve
453 curve
M braking moment
μ friction value
NB regenerative braking
pZ previous cycle
S slip
SS setpoint slip
SZa cycle segment
SZ1 first sub-cycle
SZ2 second sub-cycle
t time
t1 first time-point
t2 second time-point
t3 third time-point
t4 fourth time-point
Z cycle

1. A method for regulating a generator braking moment of an electric drive for a vehicle, the method comprising:
sensing a call for braking for purposes of braking the vehicle using a setpoint braking moment; and,
regulating the generator braking moment in dependence upon the setpoint braking moment and on a trigger condition;
wherein said regulating is effected within a plurality of cycles;
wherein within one of the plurality of cycles changing of the generator braking moment provided by the electric drive is effected;
wherein each of the plurality of cycles includes a first sub-cycle and a second sub-cycle; and,
wherein in the first sub-cycle the changing includes reducing the generator braking moment, and in the second sub-cycle the changing includes increasing the generator braking moment.

2. The method of claim 1, wherein the generator braking moment is changed such that the generator braking moment does not change sign within one of the plurality of cycles.

3. The method of claim 1, wherein a new one of the plurality of cycles begins upon the trigger condition being fulfilled.

4. The method of claim 1, wherein the changing is effected according to a variable rate of change.

5. The method of claim 4, wherein the variable rate of change is dependent upon at least one of a roadway characteristic and a driving status.

6. The method of claim 4, wherein the rate of change is limited such that the trigger condition is not fulfilled within a predefined cycle segment.

7. The method of claim 1, wherein, within one of the plurality of cycles, the reducing is effected at a first rate of change and the increasing at a second rate of change; and, the first rate of change is different in amount from the second rate of change.

8. The method of claim 1, wherein a change in braking moment relating to the generator braking moment is effected within one of the plurality of cycles; and, the regulating is effected in consideration of a previous change in braking moment of a previous cycle.

9. The method of claim 8, wherein the change in braking moment is selected in consideration of a first threshold-value condition relating to the previous change in the braking moment.

10. The method of claim 1, wherein the trigger condition is dependent upon at least one of a wheel acceleration, a change in the wheel acceleration over time, a slip, a total braking moment, and a change over time in the total braking moment.

11. The method of claim 1 further comprising regulating a friction-braking moment, provided by a friction-braking system, in dependence upon a second threshold-value condition relating to the generator braking moment.

12. The method of claim 1, wherein slip-based regulating of the generator braking moment is effected between two of the plurality of cycles.

13. The method of claim 1, wherein, upon the trigger condition being fulfilled, reducing of the generator braking moment is effected to a predefined proportion of the generator braking moment upon the fulfilling of the trigger condition.

14. The method of claim 1, wherein the vehicle is a utility vehicle.

15. A computer program comprising:
program code stored on a non-transitory computer readable storage medium; and,
said program code being configured, when executed by a processor, to perform the method of claim 1.

16. A computer readable medium comprising:
a non-transitory computer readable storage medium having program code stored thereon; and,
said program code being configured, when executed by a processor, to perform the method of claim 1.

17. A control device for a vehicle, the control device comprising:
a processor;
a non-transitory computer readable storage medium having program code stored thereon for regulating a generator braking moment of an electric drive for the vehicle;
said program code being configured, when executed by said processor, to:
sense a call for braking for purposes of braking the vehicle using a setpoint braking moment; and,
regulate the generator braking moment in dependence upon the setpoint braking moment and on a trigger condition;
wherein said regulating is effected within a plurality of cycles;
wherein within one of the plurality of cycles changing of the generator braking moment provided by the electric drive is effected;
wherein each of the plurality of cycles includes a first sub-cycle and a second sub-cycle; and,
wherein in the first sub-cycle the changing includes reducing the generator braking moment, and in the second sub-cycle the changing includes increasing the generator braking moment.

18. An electric drive for a vehicle, the electric drive comprising the control device of claim 17.

19. An electric braking system for a vehicle comprising the control device of claim 17.

20. A vehicle comprising:
an electric drive;
a control device including a processor and a non-transitory computer readable storage medium having program code stored thereon for regulating a generator braking moment of said electric drive for the vehicle;
said program code being configured, when executed by said processor, to:
sense a call for braking for the purposes of braking the vehicle using a setpoint braking moment; and,
regulate the generator braking moment in dependence upon the setpoint braking moment and on a trigger condition;
wherein said regulating is effected within a plurality of cycles;
wherein within one of the plurality of cycles changing of the generator braking moment provided by said electric drive is effected;
wherein each of the plurality of cycles includes a first sub-cycle and a second sub-cycle and,
wherein in the first sub-cycle the changing includes reducing the generator braking moment, and in the second sub-cycle the changing includes increasing the generator braking moment.

21. The vehicle of claim 20, wherein the vehicle is a utility vehicle.
